(19) United States
(12) Patent Application Publication
(10) Pub. No.: US 2025/0094711 A1
(43) Pub. Date: Mar. 20, 2025

(54) KEYWORD GENERATION SYSTEM AND METHOD

(71) Applicant: Demand Science Group, LLC, Danvers, MA (US)

(72) Inventor: Raghunandan Mishra, Danvers, MA (US)

(73) Assignee: Demand Science Group, LLC, Danvers, MA (US)

(21) Appl. No.: 18/888,104

(22) Filed: Sep. 17, 2024

(30) Foreign Application Priority Data
Sep. 20, 2023 (IN) 202341063053

(51) Int. Cl. G06F 40/284; G06F 40/40

(52) U.S. Cl. CPC G06F 40/284; G06F 40/40

(57) ABSTRACT

A system and method for more granular keyword generation wherein the keyword generation may be used for content syndication or other activities. The keyword generation may be performed using a plurality of artificial intelligence models including a topic classifier, a keyword scorer and a keyword ranker and recommender. The keyword generation system and method may discover keywords weighted by business categories.

### PRIORITY CLAIM

This application claims priority under 35 USC 119(a)-(d) to Indian Provisional Application Serial No. 202341063053 filed Sep. 20, 2023 and incorporated herein by reference.

### FIELD

The disclosure relates generally to generating keywords for identifying interests of user and in particular to generating keywords for identifying interests of user using ensemble artificial learning techniques.

### BACKGROUND

As of October 2021, it is estimated that there are about 1.18 billion websites on the Internet with about 200 million being active and 10,500 new websites being added every hour. The websites are from several industries, domains, with different end users and persona. The business-to-business (B2B) domain represents a significant part of the websites that is targeted towards an audience (and audience members) that are different from general citizen consumers. The process of sales and marketing of products and services from one business or enterprise to another forms the scope for B2B related content. Unlike consumer sales, the cycle time for selling products to an enterprise is longer, the volumes are lower, and the value of a single sale is higher. Furthermore, the buying organization does a lot more research about the product or the service before committing. Hence, B2B sales are dependent on the consumption of product content published by the sellers on their websites. The textual content may be in the form of product datasheets, case studies, white papers, and references that may be used for B2B sales through content syndication.

Targeting the right audience in the B2B domain requires usage of terms and phrases in the content that is immediately recognized by the target audiences. B2B is a vast domain space that has multiple subdomains that are distinct from each other. For example, biotechnology, Finance, Healthcare and Technology are some of the subdomains that are a part of B2B in general. Each subdomain has its own unique characteristics so that, for example, similar terms have different meanings in different subdomains. For example, the usage and meaning of the term “taxation” could take different meanings in legal, corporate finance and personal finance domains. On the other hand, subdomains are inter-connected and there are overlaps too. It is important to recognize the degree of separateness or closeness between domains.

As a result of these B2B domain issues, it is desirable to be able to extract, analyze and evaluate the importance of keywords in the business domain such that the importance is determined at the subdomain level and there is a need for understanding and extracting keywords from document in the business domains such that the nuances of sub-domains contribute to the most important term. The problem of automatic keyword extraction has been studied for a long time now, although there is hardly any material in the domain of B2B.

Technically, keyword extraction may be considered as a modified use-case of information extraction. Information extraction primarily focuses on extracting factual data from text while the problem of keyword extraction is to identify words or phrases (present or absent) that can explain the core concept of the document. Keywords explain the gist of the content in a few words or phrases, without missing anything important, and explain it precisely. Several techniques have been applied to extract and generate keywords previously. However, the problem remains non-trivial, in the sense that even the state-of-the-art solution gives a low f-Score meaning that the state-of-the-art solutions have low accuracy. One of the unsolved technical problems in this task arises because the target space is unbounded. For example, it is estimated that around 15% of the words that are keywords are not necessarily found in the source text. Among the words present, the expression of author assigned keywords (also referred as golden keywords) may not necessarily be in the same sequence as it appears in the source document.

FIG. 1 shows the importance of words in the content of a document and explains the unbounded target space technical problem. In the example in FIG. 1, the keyword “sustainable city” assigned by the author does not exist per se in the title or the abstract. The importance of this keyword is clearly determined in the context of the document. Thus, the topic or the concept that is being discussed in the document drives the importance of a keyword.

Most of the keyword extraction solution focus on determining the importance of a term (quantitatively) with a given corpus. Depending on the type of corpus, an importance score is calculated for each term. However, that does not consider lower-level topic within the corpus. It is found that in most cases, the corpus is very broad (for example, the entire Wikipedia), or narrow (for example, scientific papers) depending on the use case. Once the corpus is decided, there is no attempt made to determine the importance depending on the various topic discussed within it. The gap in extracting keywords in the B2B domain is thus compounded by lack of domain focus and a general solution that can work at the sub-domain level. To summarize the open issues in this field, the prediction in cross domain area is difficult. The above problems are aggravated by the lack of availability of large corpus of labelled dataset in the business domain which limits the choice of methodology.

Machine Learning for keyword extraction has been used since the 1990s. The choice of methodology and algorithm has changed over time and evolved along with the natural language processing capabilities. Several techniques have been used including machine learning, graphical methods, and deep learning algorithms. The problem areas, however, remain the same and generalizing the model to perform across multiple domains and use cases has been a key challenge. This was recognized as a problem area very early and it remains one of the important considerations for choosing the right methodology. Most of the experimentation conducted is around scientific literature due to availability of dataset and presence of diverse topics within that domain. There are a couple of studies on contextualized advertisement and social media interactions. B2B is a super set of domains where not much has been experimented.

In the B2B domain, contextualized advertisement uses keyword solution to enable searching content based on the search query. Search engine economy explores the behavioral aspects of readers in depth to predict the terms that a user is likely to search. Using such key terms organically within the content, bumps up the ranking of articles based on relevance in the search engine results page. Although the use case is complimentary to automatic keyword extraction, the underlying technology is very different. In contextual ad, the goal is to seed keywords in documents for efficient search, while it is desirable to extract and assign importance of keywords that are important for various business topics which cannot be done with the contextual ads techniques.

There are various known machine learning approaches that extract features that contribute to the importance of a keyword which are shown in FIG. 2. The limitations of these approaches can be seen clearly. Resource-based methods each use a dictionary that is not scalable. None of the known techniques use a combination of syntactical, statistical, and semantic methods and specifically, the statistical calculation of a scoring system that is applied at scale to determine keyword importance for several business topics (˜7500). Some known keyword extraction techniques used supervised methods as shown in FIG. 3.

Thus, it is desirable to provide a keyword generation/discovery system and method that discovers keywords weighted by business categories (more granular that typical systems) and it is to this end that the disclosure is directed.

### BRIEF DESCRIPTION OF THE DRAWINGS

FIG. 1 shows the importance of a word in the content of a document;

FIG. 2 illustrates known machine learning techniques to extract features of keywords;

FIG. 3 is a diagram illustrating known supervised keyword extraction methods;

FIG. 4 is an example of a content syndication system that has a keyword generator;

FIG. 5 is a flowchart of a method for generating and recommending keywords;

FIG. 6 is an example of an article from which keywords are generated;

FIG. 7 illustrates an example of five keywords generated by a conventional system from the article in FIG. 6;

FIG. 8 illustrates the business domains generated based on the example article in FIG. 7;

FIG. 9 illustrates the keyword generation results of the system in FIG. 4;

FIG. 10 illustrates more details of the keyword generation and recommendation method of FIG. 5;

FIG. 11 illustrates more details of the topic classifier shown in FIG. 5;

FIG. 12 illustrates more details of a method for creation and maintenance of a topical taxonomy;

FIG. 13 illustrates more details of the topic classifier dataset preparation process 112;

FIG. 14 illustrates more details of topic classifier training 113 in FIG. 11;

FIG. 15 illustrates more details of candidate extraction process 53 in FIG. 5;

FIG. 16 illustrates an example of a maximal marginal relevance determination;

FIG. 17 illustrates an example of a keyword scoring process to determine a term domain score;

FIG. 18 illustrates high value keyword dictionary curation and maintenance;

FIG. 19 illustrates an example of the features for keywords;

FIG. 20 illustrates more details of a keyword clustering and ranking process;

FIG. 21 illustrates an example of an algorithm used for keyword clustering and ranking; and

FIG. 22 illustrates an example of the NVP rules.

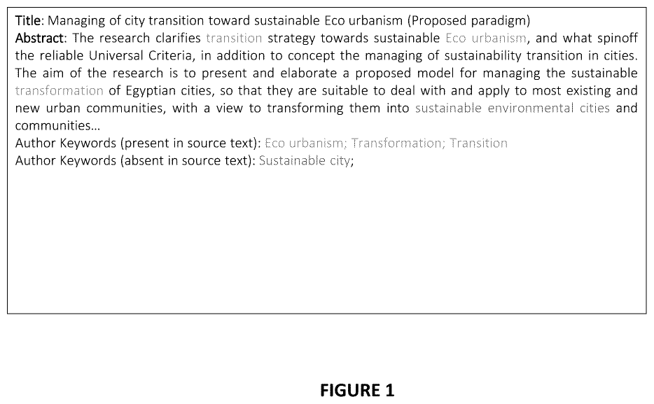

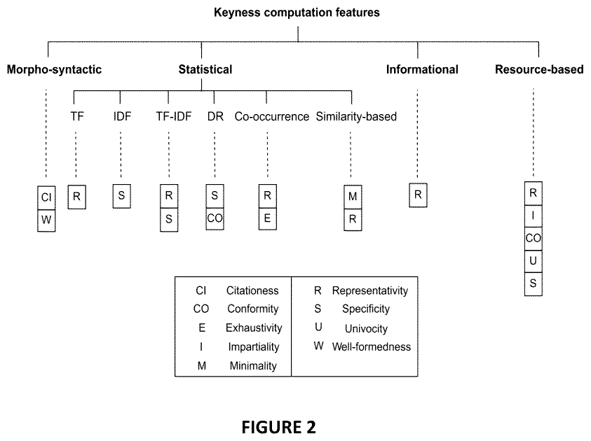

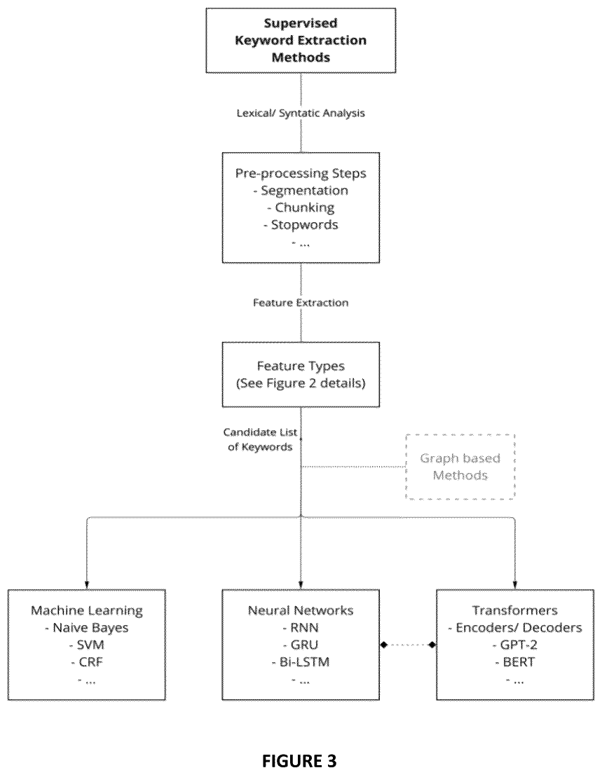

### DETAILED DESCRIPTION OF ONE OR MORE EMBODIMENTS

The disclosure is particularly applicable to a keyword generation system and method that may be used to improve a content syndication system for documents and it is in this context that the disclosure will be described. It will be appreciated, however, that the keyword generation system and method has greater utility since it can be implemented as a tool through application programming interfaces (APIs) so that any third party business to business (B2B) service or product with a license can take advantage of the generated keywords. Furthermore, the keyword generation system and method may be used to improve other system and methods, such as for the analysis of audio content and/or to generate keywords by persona. Furthermore, the system and method may be used by various different pieces of content. For example, audio content, such as a podcast, video, etc. may be used in the system wherein commercially available audio to text transcription/conversion may be used before performing the keyword determination. The keyword generation system and method also may be implemented using other architectures and computer systems that those shown in the drawings. In this disclosure, the term “keyword” may refer to a word or a sequence of words or phrases, each of which may or may not be present in the piece of content.

The keyword generation system and method define the context of a document/piece of content by classifying the piece of content into B2B categories and based on the determined category for each piece of content, re-ranks keywords relevant to the topical category of the document resulting in high-quality precise keywords. The keyword generation system and method may combine unsupervised machine learning and supervised learning. The keyword generation system and method uses training documents to train the AI/ML model(s), but uses a novel training approach that does not consider the training corpus as a single entity. Instead, the training document is divided into business categories using a proprietary ‘Topic Classifier model’ described below in more detail. In one implementation, the model may harness a hierarchy of category>>topics in which there may be about 175 Business Categories and about 7500 Business Topics. The keyword generation system may have a second model, a ‘Candidate Extractor and scorer’, that calculates the importance of candidate terms in form of a score by using a combination of both the corpus and the category to which the document belongs. The keyword generation system also may train a supervised ‘Keyword Re-ranker model’ that uses the candidate term, its importance score, and the document category as a key feature to score and re-rank the keywords. Based on new rank, model assigns precise keywords to each business category and make it granular by calculating the importance of keyword at topic level. The significant benefit of the approach is the extraction and ranking process is based on relevance of the keyword for a category rather than having a generic corpus. The categories that are of focus are part of the B2B domain that makes it very accurate for campaign content targeting. The model provides an ability to produce a granular list of high-ranking keywords by business categories and topics instead of keywords that are trending in general. Each of the machine learning models disclosed herein may be implemented using a plurality of lines of instructions/computer code that instantiate each machine learning model (whether supervised or unsupervised) when executed by a processor of the computer system. The computer system may also include one or more processors/GPUs that may be used to train each of the machine learning models. Each model may be implemented using different machine learning techniques, such as a known transformer or other techniques.

In one embodiment, the system and method takes advantage of the fact that the context of a given word and its relationship with other words gives a good insight into the importance of the word. Determination of the word importance can be approached by applying simple rules, or doing lexical, syntactic, and semantic analysis. Although, all methods follow one or a combination of the above, the analysis is performed at the corpus level rather than the more granular (lower level) topic level as is done in the below described novel keyword generation system and method. Analyzing the importance at the topic level introduces several technology challenges that are solved as a part of this disclosed system and method.

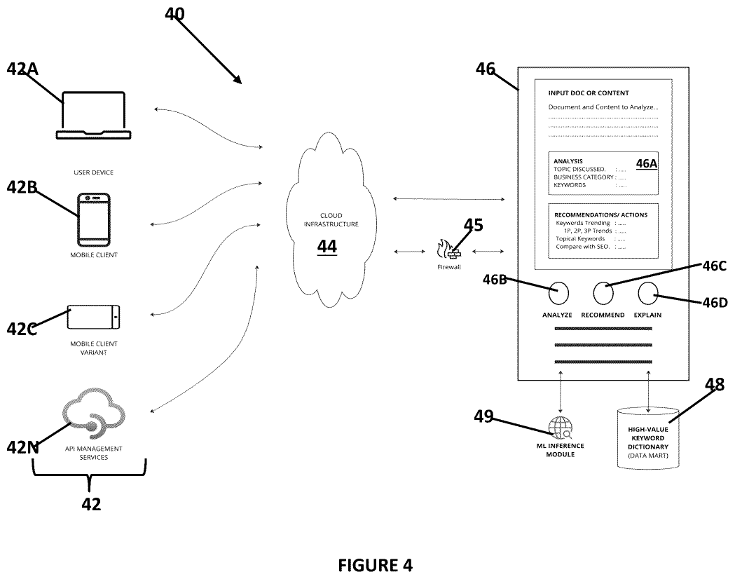

FIG. 4 is an example of a content syndication system 40 that has a business domain keyword generator. In addition to content syndication for B2B marketing discussed below as the example use case, the keyword generation system and method may be used for the analysis of audio content or to categorize keywords by persona as discussed below in more detail. In addition to the architecture of the system 40 shown in FIG. 4, the system or keyword generator may be implemented as a standalone system that distributes the generated keywords via an application programming interface (API) to third parties.

In each of the different possible alternatives of the system 40, a user may use a computing device 42 to connect to, communicate with and access a backend system 46 over a communications path 44 in order to perform certain actions or services such as generating and providing more granular keywords that may be used for content syndication. Thus, the user connects to and communicates with the backend system 46, the system 46 performs its functions and returns results to the user (the more granular keywords) in a user interface generated by a user interface engine of the backend system 46. The keyword generation may be generated in the same manner for both the content syndication, standalone operation, audio content keyword generation and keywords by persona. Furthermore, although the keyword generation engine 46A shown in FIG. 4 is part of the backend system 46, the keyword generator engine 46A may be an independent system that, for example, provides requested keywords to third parties such as by using an API.

The system 40 may have a plurality of computing devices 42A, 42B, 4C . . , 4N that can each independently access the system 46 over the communications path 44. Each computing device may have a processor, memory, wireless or wired connectivity circuits to connect to the system 46 and a display wherein the memory stores a known browser application, such as Google® Chrome®, etc., that is a plurality of lines of instructions executed by the processor that allows the user to interact with the system 46 in a known manner. Alternatively, the processor of each computing device 42 may execute a mobile app or other application that is a plurality of lines of instructions executed by the processor that allows the user to interact with the system 46 in a known manner. The system 46 may send back data or HTML pages with the search results (including the generated keywords) that are converted into a user interface by the browser or application and displayed on the display of the computing device.

As shown in FIG. 4, each computing device 42 may be a different device such as a user device 42A, such as a laptop computer, a mobile client 42B, such as a smartphone device, a mobile client variant 42B, such as a tablet computer, a personal computer, a smartphone device, an API management system 42N or any other device that is capable of connecting to and communicating with the backend system 46. The communications path 44 may be a wireless and/or wired path (or a combination of wired and wireless systems or networks) that may be secure or unsecure. In one embodiment, the communication path may include a known firewall 45 for secure communications.

The backend system 46 may be implemented by one or more computing resources, such as server computers, blade servers, cloud computing resources, etc. that have at least one processor and memory that store and execute a plurality of lines of instructions/computer code to perform the search and scoring operations of the backend system 46. The system 46 may have a keyword generator 46A and a keyword recommender that generates and recommends more granular keywords that may be used for content syndication. The backend system 46 may have one or more hardware or software storage devices 48 that may be hardware or software or a combination of hardware and software and store the data used for the system including the software for the various engines, user data, training data for the AI and a high value keyword dictionary. The backend system 46 may also have an ML inference module 49 connected that performs the more granular keyword generation. The storage devices 48 may also store the training data for the AI techniques, the resultant generated keywords.

In a preferred embodiment, the system may be exposed to end users on several types of devices including laptops, mobile and tablets of different resolution and sizes. The backend 46 of the system itself is hosted on a cloud infrastructure. Access to internal users is primarily controlled by a firewall that requires the user to have necessary organizational access credentials. External users can access different modules using API keys that is shared based on subscription. The implication is that certain functions are available only within the company firewalls or through a subscription or license. External systems can be integrated with the API endpoints that are exposed via the cloud infrastructure.

The system 40 as shown in FIG. 4 may have three main module from an end user's perspective: (i) the analysis of content or document (46B); (ii) the recommendations (46C) made by system at business category and topic level; and (iii) the explanation (46D) of the analysis and recommendations. The analysis module 46B includes a plurality of/group of machine learning models that has the ability to extract ‘k’ number of keywords for a given input document in which the relevance of keyword are determined at the business category and topic levels in the extraction process. The recommendation module 46C uses a dictionary of high value keywords that is periodically maintained and stored in a database to recommend keywords. These keywords are curated by a machine learning model that analyzes millions of real-world documents and uses statistical and semantic methods to rate the keywords by business category and topics. Finally, the explainer module 46D uses the keyword features and tags generated by the analysis 46B and recommendation modules 46C to provide necessary evidences for why certain keywords are important for a document in the context of business categories and topics.

The backend system 46 may have internal tools that call special APIs that can be accessed within the firewalls of the cloud infrastructure in which a solution is deployed. There are two major solutions where this technologies are being used. An intent scoring engine analyzes millions of documents birthday and uses the keywords analysis module 46B to extract keywords from each of the document and then uses the recommendation module 46C to match high value keywords that are trending to determine the quality of the document being analyzed. The higher the matching score the better the document quality. This eventually feeds into scoring of buyer's intent based on keyword as one of the features.

The backend system 46 may also have an internal tool for campaign management for content syndication that is a representation of the workflow that uses keyword analysis, recommendation, and explainer modules 46B-46D. In this solution, individual documents are uploaded in a content workspace and campaign managers visualize and accept the recommendation based on the explanations, to modify the documents in real time. This system uses several other recommendations such as recommendation of target audience, persona, and industry to complement the keyword analysis module. A new machine learning module may generate recommendations for different industries and personas to complement the current content based recommendations.

The keyword analysis, recommendation, and explainer modules 46B-46D may be exposed by an API that is accessible by any B2B platform to receive the more granular generated keywords. The API can be invoked by external users having appropriate level of identity and access resolution. In a service-oriented architecture, each API is exposed as a microservice to the calling application that can be integrated with any external third-party system. The use cases for high quality keyword analysis and recommendation can vary by the needs of a customer and hence the API platform is expected to cater to several different kinds of use cases for keywords. The functionality or the feature offered by the API is similar to the internal system as explained above.

The keyword generation system 46A and modules 46B-46D may be preferable implemented to include machine learning development and deployment and system development and deployment. The machine learning development and deployment may include training module hardware and software requirements. The training module hardware requirements may be a single GPU instance with at least 16 GB RAM. Amazon® AWS® instance (or its equivalent) would help as they have pre-configured environment with necessary TensorFlow and Pytorch libraries to train the models. The training modules software requirement may be Python using Jupyter Notebook IDE is the programming language and also uses open-source libraries for model development, training, and testing the machine learning algorithms.

The keyword generation system 46A and modules 46B-46D may be preferable implemented to include the system development and deployment including machine learning module deployment and solution deployment. The machine learning module deployment may include machine learning inference scripts that are written in python and dockerized. The docker containers are deployed on cloud by exposing the API endpoints. Modules that require to be within the firewalls have different level of access controls. The access to APIs by external parties is controlled via API keys that are shared with the users or subscribers. The solution deployment may include the application being tested internally on an AI playground platform before exposing any component to external facing applications. A user interface module is built using React and JavaScript components that are integrated with the API endpoints. In some cases, the APIs are built and exposed in Golang programming language for efficiency gains but are largely built on Python.

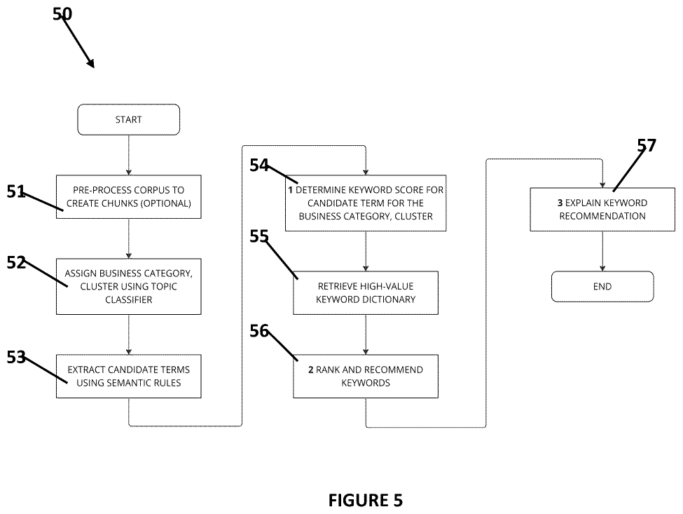

FIG. 5 is a flowchart of a method 50 for generating and recommending keywords that may be performed using the system example in FIG. 4 or by other systems. In one embodiment, the processes of the method may be performed by a processor/GPU executing a plurality of lines of computer code/instructions so that the processor/GPU is configured to perform each process of the method. The processes 54, 56, and 57 of the method are numbered and are the processed performed by the analysis module 46B, the recommender module 46C and the explainer module 46D in FIG. 4.

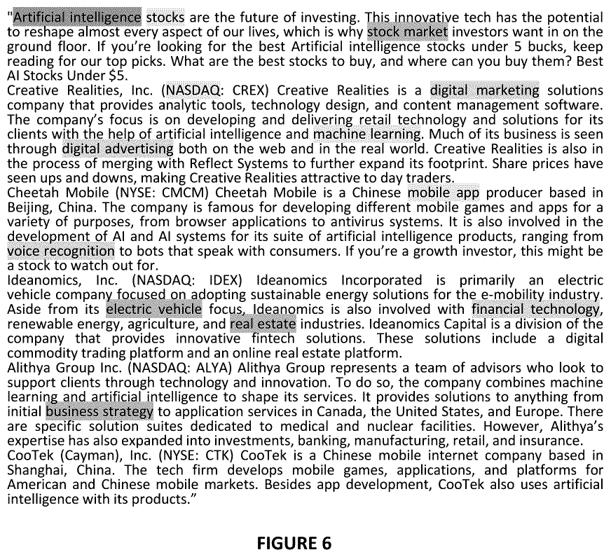

To understand the method 50 in FIG. 5, it is important to understand certain details of keywords in the B2B domain. B2B websites rely on keywords for the search engines to crawl and present its content in the search engine results page (SERP). This creates a unique challenge for the business websites. How do they know exactly what their buyers are looking for? To answer this question, they need to understand how buyers and prospects are formulating their queries, questions, or problem statements (what keywords are being used), while searching on the Internet. In a competitive environment, businesses also need to analyze the content space of the competition and identify key terms used by them. Such analysis helps them to generate contents with popular keywords that are relevant for the domain. Consider an excerpt from an article shown in FIG. 6. The goal of the method is to determine the keywords relevant for this article.

FIG. 6 shows an excerpt of a sample document in which it is desirable to determine the keywords pertinent to the document. The sample document is primarily about stock market investment in technology firms. The article describes the strengths of products and services offered by few companies to justify its stock price and investment value. This article although is primarily an investment guide, it has details about technologies and solution that may be of interest for a user who is looking for information about companies that offer solutions using artificial intelligence technology. Known and existing keyword extraction solution would just produce a set of keywords without giving any context of the domain that these keywords may belong to. Using the method disclosed in FIG. 5, different sets of keywords are extracted by the system for different domains. Users may choose any context of their interest in form of business categories and topics, and the solution extracts keywords that they may find useful and interesting.

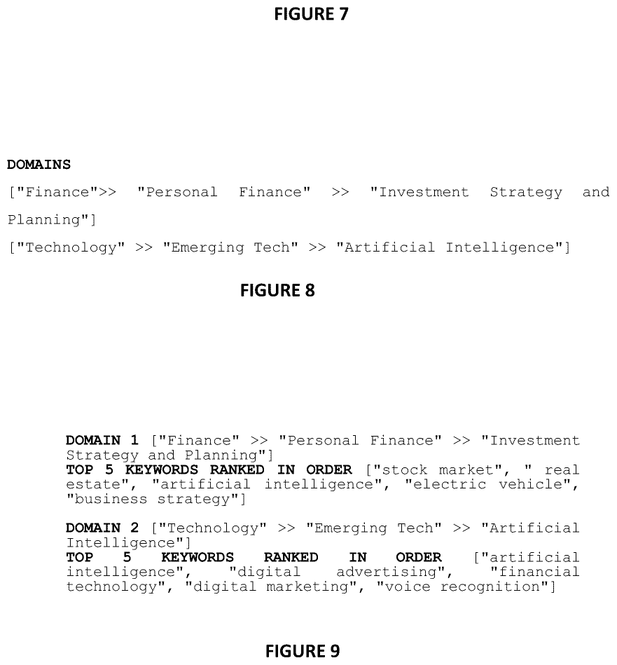

The known and conventional techniques, such as using OpenAI's ChatGPT-3.5, generated keywords marked in yellow in the example article in FIG. 6. The keyword ‘artificial intelligence’ is suggested by all the systems and hence marked in green in FIG. 6. This is the best available model for any natural language task including keyword extraction. Although, the model has produced top 5 keywords in-line with the major theme of the article i.e., investments, it is unable to differentiate the keywords based on user's interest. Note that the GPT was prompted to produce top 5 keywords, and the results produced are shown in FIG. 7. The response by the conventional solution does indicate in the response that the top 5 is subjective in nature, reinforcing the need for a better solution that is now described with reference to FIG. 5.

The analysis module 46B shown in FIG. 4 and its processes shown in FIG. 5 are powered by multiple real-time machine learning inference models. The models sometimes (optionally) need larger documents (from the corpus) to be chunked into smaller size (process 51) to fit into the inference capabilities of the particular machine learning inference model. Further, certain other technical pre-processing steps may be applied to prepare the document chunks to feed into the model input in a known manner. For example, working within the limitations of the fine-tuned language model, documents that are longer than 512 words are broken into several chunks with each chunk being 512 words. In some embodiments, if a document has separate title and contents, both are combined and occurrences of numbers, formulas, punctuations, and special characters are deleted from the text to make the processing easier. In some embodiments, the text may be converted into lowercase. The piece of content may be segmented into sentences, and sentence into tokens and parts of speech (POS) tags are assigned to the tokens. Stop words are removed using standard NLTK library and the output is lemmatized using the WordNetLemmatizer library.

The original document or chunks may be fed into a topic classifer machine learning inference model that assigns business topics to the content (52). The business category and topic are a hierarchical taxonomy system that is periodically updated to reflect business realities. The model is based on transformer technology applied to natural language and is fine tuned to understand underlying concepts of the document. The documents/chunks having the same assigned business topic may be clustered together as discussed below in more detail. Returning to the example in FIG. 6, the topic classifer process determines three major themes of the article using the ‘Topic Classifier’ model. These may be called as business domains, sub-domains, categories, topics etc. For the illustrative article in FIG. 6, the model assigns two topics from the Taxonomy to this illustrative article as shown in FIG. 8.

The resulting documents/chunks with their assigned business topics may be input to a set of ‘syntactic rules engines’ that extracts, using semantic rules, all candidates of terms that have the potential to be a keyword in the document (53). The ‘syntactic rules engines’ use optimization techniques to determine the length of keywords and reduce redundancies of candidate terms as described below in more detail.

The final process of the analysis module 46B scores and rank each of the candidate keywords (process 54). In one embodiment, the score may be performed using the standard term-frequency and inverse-document-frequency measures but modifies these scores using an inventive measure called as ‘inverse-domain-frequency’ to determine the relative ranking of the term against several categories and topics. The final rank and score thus obtained is displayed as a set of keywords that are extracted by the module. When the categories and topics are used as inputs to the ‘Keyword Scorer’ model to extract different and relevant keywords for each topic, as seen in the illustrative article in FIG. 6, the generated keywords in the context of domain ‘investment strategy and planning’ are marked in blue, while those from domain ‘artificial intelligence’ is marked in grey. The keyword which is common to all the system i.e., ‘artificial intelligence’ is marked in green. An example of the result from keyword system and method in FIGS. 4-5 is shown in FIG. 9.

Returning to FIG. 5, the recommendation module 46C and its processes analyze millions of B2B documents every day to discover trending keywords by categories and topics. The underlying model ‘keyword clustering and ranker’ tracks the occurrence of keywords for each category and topic in real-time and assigns a probability weights to a set of trending keywords. The model output is thus, a set of high-value keywords that are periodically updated and stored in a database in form of a dictionary for faster retrieval (process 55). If a keyword from the analysis process is also found in the high-value keyword dictionary, the keyword is scored and ranked again (process 56). In case a high-value keyword in the dictionary is missing in the document, a recommendation is made to the user.

Changes to the topic taxonomy such as inclusion of new topics results in major update to all the models. The model also updates the high-value keywords periodically based on several features like overall counts, count by users, recency, and velocity.

The explainer module 46D describes the recommendation is greater detail (process 57). This module 46D uses the features generated from the recommendation module with certain meta tags that are important to understand those recommendations. The metatags includes count of the content analyzed, the recency factor, the velocity factor, and links to URL's that contribute to the importance of the keyword.

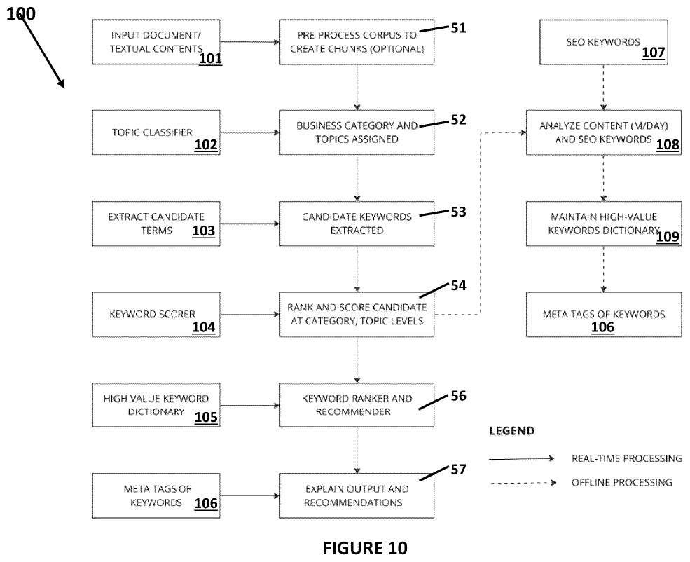

FIG. 10 illustrates more details of the keyword generation and recommendation method of FIG. 5 in which the same processes in FIG. 5 (processes 51-57) that have the same function/operation described above have the same reference numbers and will not be further described with reference to FIG. 10. In FIG. 10, an initial process 101 involves inputting of the content that may be textual content or audio content or a combination of the two types of content. If the input documents include audio content, then a process (not shown) is used that transcribes each piece of audio content into text. All of the inputs are optionally pre-processed 51 as described above. As shown in FIG. 10, the overall keyword generation method may have one or more sub-modules including a topic classifier process 102, a term extraction process 103, a keyword scorer process 104, a high value keyword dictionary 105 and a meta tags of keywords 106 that perform the processes 51-57 shown in FIG. 5. Each of the sub-modules may be implemented as a plurality of lines of instructions/computer code executed by the processor to perform the operations.

As shown in FIG. 10, processes 51-57 performed by the sub-modules 101-106 are each performed in real-time (marked by the solid line connecting these processes) when keywords are being requested. The method 100 may also have several offline processes (marked by the dotted lines) that can be performed in the background. For these offline processes, the output from the ranking and scoring of keywords process 54 may be fed with SEO keywords 107 into an analyze content (million per day) and search engine optimization keywords process 108. The process 108 may be used to generate and maintain the high-value keyword dictionary (109). Meta tags of the keywords may also be generated (106) during this offline processing. The generation of the meta tags is described above.

### Topic Classification

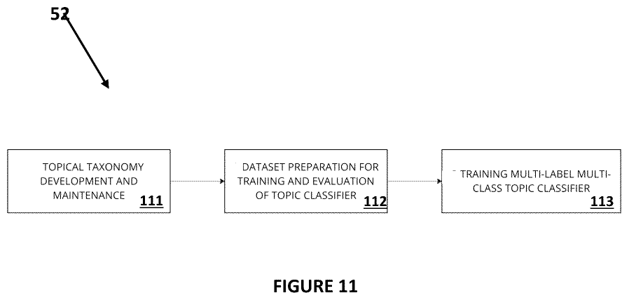

FIG. 11 illustrates more details of the topic classifier process 52 shown in FIG. 5. The assigning of topics to a piece of content (document, audio content, etc.) is unique for keyword analysis. Most known keyword analyzers do not recognize keywords in the context of specific domains and subdomains and thus do not perform topic classification. To achieve the topic classification, the process 52 may include a topical taxonomy development and maintenance component 111, a dataset preparation for training and evaluation of topic classifier component 112 and a training multi-label multi-class topic classifier component 113. Each of these components may be implemented using a plurality of lines of instructions/computer code that are executed by a processor of the computer system that generates the keywords so that the processor is configured to perform each of these processes that will now be described in more detail.

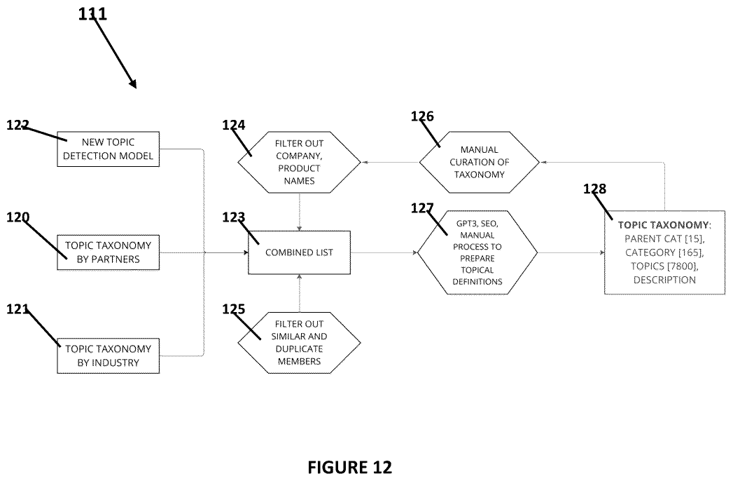

The topical taxonomy development and maintenance process 111 generates an unambiguous definition of business taxonomy in the B2B domain which is needed to support the unique solution of analyzing keyword in the context of business category. To achieve the same, a software component is developed for creation and maintenance of such a business taxonomy as shown in FIG. 12. This is an important component that ensures a robust and scalable system of document classification that feeds the domain and sub-domain information for keyword analysis. Inputs to development of the taxonomy as shown in FIG. 12 may include business categories (topic taxonomy) published by partner organizations (120) and business categories (topic taxonomy) published by several industry segments (121) who have expertise in the area. A new topic detection module 122 is also built that constantly scans for emerging business topics from the input contents and discovers potential new topics to categories. These lists are combined (123), and filters are applied to remove duplicates and semantically similar names (125). Certain topic names that have company and product names are also removed (124) to keep the taxonomy at a conceptual level. In one implementation, a program unit that uses an open-source language model generates clear and unambiguous definitions for each member of the taxonomy. The resultant taxonomy 128 itself has three-layers of hierarchical structure with Parent Category [15 members], Category [165 members], and Topics [˜7800 members]. The three layers allows granularity in document assessment and is expected to make the allocation of business category precise.

The creation and maintenance of the taxonomy in FIG. 12 may further a manual vetting of taxonomy 126 and a set of processes 127 to prepare topical definitions to vet the generated taxonomy. The process to maintain the taxonomy may be triggered when new taxonomy nodes are added or when there are significant alterations of an existing taxonomy node. When triggered, a message may be sent to a taxonomy governance group members who vet the changes and the reasons for the change to the taxonomy. If the proposed change is approved, then the change is approved for a next release cycle wherein all changes approved since the last release cycle are made.

In one implementation, the topic classifier model in a BERT based transformer architecture model that classifies business relevant content into categories and topics from a proprietary taxonomy and assigns three level hierarchical topics to documents which may be fed into a keyword scorer. The BERT based transformer model may have 320 million hyperparameters and may be trained with 300,000 documents. The pre-processing may tokenize and generate embeddings wherein the tokenization may be known byte pair encoding (BPE) and the embedding may be known Bert embeddings. The topic classifier may be a multi-label, multi-class classifier that uses natural language processing and whose training infrastructure is a 16 GB GPU. The training data for the topic classifier may have a 512K token limit and the model name, in a preferred implementation, may be google/bert_uncased_L-12_H-768_A-12, the warmup steps being len(train_dataloader)*5, the batch size may be 8, the learning rate may be 1e-5 and there may be 30 epochs. The thresholds for the training may be a maximum of 8 topics, prune topics with score that are beyond 1 standard deviation.

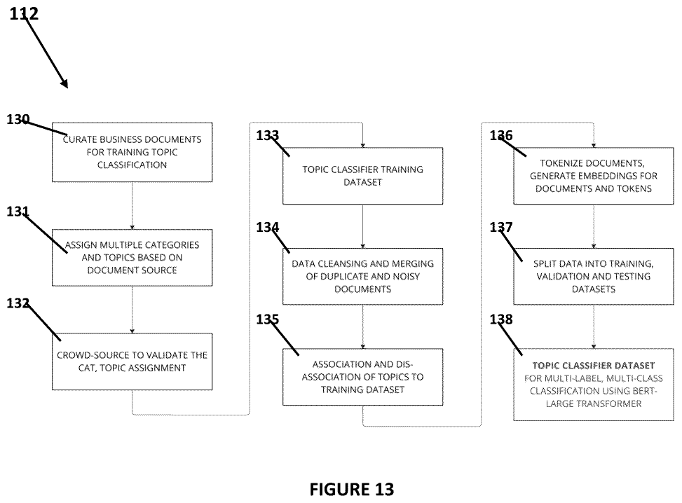

Returning to FIG. 13, the preparation of dataset for Multi-Label, Multi-Class Topic Classification 112 is used to train the topic classifier model as shown in FIG. 13. The documents for training topic classifier are curated (130) from open-source datasets and internal content syndication documents used for running campaigns. A supervised training technique is followed for training topic model. This requires each document to be labeled with one or more business topics. Since the data is curated from known and reliable sources, the tags from the document sources are used to assign one or more business categories and topics to each document (131). A crowdsourcing project (132) may be launched to validate the assignment and make corrections to obtain human verified, high quality labeled dataset for topic classification (a topic classifier training dataset 133.)

Standard data cleansing techniques (134) are applied to remove duplicates and ambiguous assignments. The resulting dataset is analyzed along two dimensions to create a balanced dataset: number of topics assigned per document, and the number of documents assigned per topic. A novel process (135) of associating topics to documents (for cases where the number of samples are less) and disassociating topics to documents (for those cases where the number of samples are very high) is created and followed as below. In particular, the association of topics to documents may use the known K-nearest neighbor (KNN) method in which, for each document, a top 50 nearest documents are identified using KNN cosine similarity on the MiniLM document embedding. For each document, the frequency of topics for the neighboring documents are counted.

For the KNN method, the training the topic model requires preparation of the business dataset in a completely different format in which the primary task is association and disassociation of topics to documents and the downstream task is topic classification. The architecture is semantic similarity, the number of hyperparameters is unsupervised and the number of documents for training may be 500K. The pre-processing may include de-duplication and under sampling for balanced dataset, tokenization may be WordPiece and embeddings may be MiniLM. The type of natural language ability may be natural language understanding, the source of training data may be proprietary data, the known OAGKX data set (details of which may be found at huggingface.co/datasets/midas/oagkx that is incorporated herein by reference), and the known SCOPUS dataset and the training Infrastructure may be a 32 GB CPU. For the training of the KNN model, there may be token limit of 2048K for a known SciKit KNN model with a top 50 similarity count and a cosine similarity function with thresholds of a z-score of 0.25 and a top N topics of 15.

Returning to FIG. 13, to add topics, two methods are evaluated. A first method filters topics based on a known z-score wherein a z-score is obtained for each topic per document. In one implementation, a z-score of 0.25 or higher is added to the pool of topics that resulted in ˜6800 topics that have 50+ documents. In the second method, the top N topics are obtained wherein N is set to 15 that results in each of the topics to have a mean of 75+ documents.

The process 135 may also disassociate topics to documents using the KNN method in which the topic Dissociation process is evaluated by filtering the Categories and the Parent Categories. Experiments are conducted to check if the resultant dataset had representation of all topics (by observing documents per topic count) and a multi-label dataset (by checking topics per document). The method for disassociation of topics may generate cosine similarity score for each sentence against the topics. Each document has ‘s’ number of sentences and each document has ‘n’ number of topics because of topic association using KNN. Given a document that has s=5 (5 sentences) and n=8 (8 topics), the method obtains all cosine similarities between ‘s’ sentences and ‘n’ topics that will result in an array of size 5 by 8 (5 rows and 8 columns) with each row contains cosine similarity scores of each sentence vs 8 topics. The disassociation method also may obtain the standard deviation ‘std’ of all cosine similarity scores above and use this as the threshold. Thus, a sum of all topic scores that are greater than ‘std’ are used as final scores to rank the topics in terms of relevance to documents. Using the ranks, remove the topics that do not belong to top 5 most common categories.

The tokenize process 136 may tokenize each document using Byte Pair Encoding (BPE) method. The method splits a piece of text (or word) into smaller units called tokens. To generate tokens, each word is split into its lowest unit (character) and pairs of characters that occur frequently by count are added to a vocabulary. BPE ensures the vocabulary size is not very large (typically 50K) while also ensuring that out-of-vocabulary words and rare words are also recognized by the model using this tokenization method. The classifier uses standard BERT embedding that uses the tokenized text created as above, and appends certain special tokens, sentence segmentation IDs, and positional embeddings to it. All these are passed together as initial embedding for each token in the input layer of BERT model.

The split data process 137 may split the data into training data, testing data and validation data. Thus, the full dataset for training topic classifier consists of ˜300K documents of varying length (in terms of number of tokens). This data is split into 70:20:10 ratio using a random sampling method to create training, validation, and testing dataset respectively. This process ensures that the trained model is validated using a dataset unseen during training (therefore avoiding data leakage problem). The final test dataset is used evaluating model independent of training and validation process. The resulting training dataset may be the topic classifier dataset 138 that is used to train the topic classifier model.

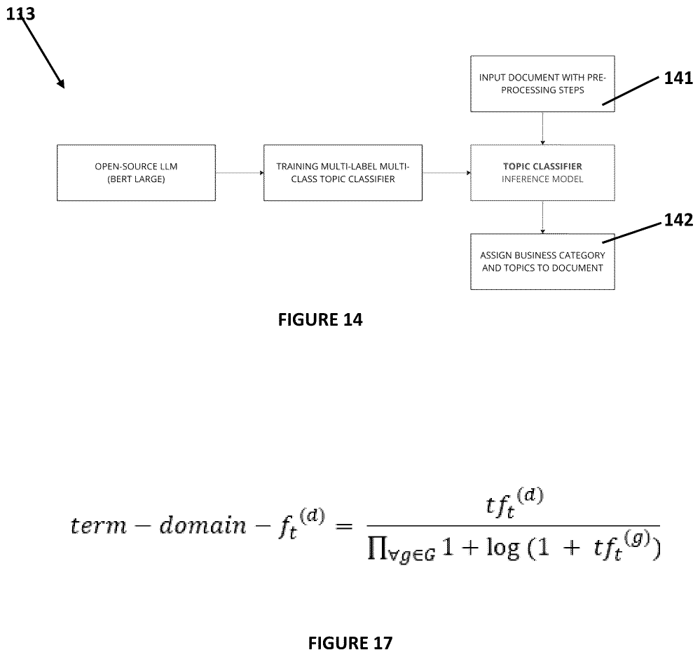

The method, using the training data from the method in FIG. 13, may train the topic classifier (113) as shown in FIG. 14. A known BERT-Large model may be trained on the topic training dataset. Fine-tuning of BERT-Large model is executed on a 16 GB GPU machine and the best model was obtained with the following run-time parameters:

MODEL_NAME = “google/bert_uncased_L-12_H-768_A-12”

| | |
|---|---|
| WARMUP_STEPS = len(train_dataloader)*5 | # 5 epochs worth of steps |
| BATCH_SIZE = 8 | # mini batch size |
| LEARNING_RATE = 1e−5 | # initial learning rate of model |
| NUM_EPOCHS = 30 | # number of epochs to run |

Once the topic classifier model is trained, the model is dockerized and deployed on a GPU machine for high-scale inference. The topic classifier model receives all of the keyword training documents (141) as an input batch to assign business categories and topics to each document (142).

### Candidate Extraction

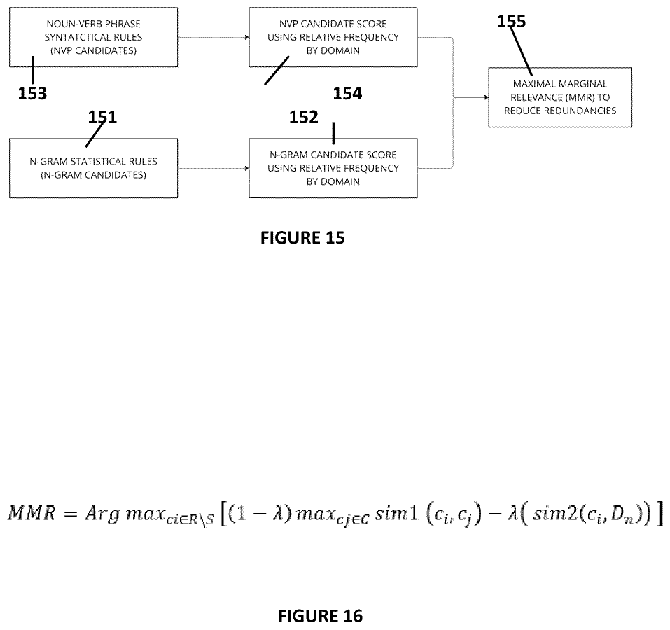

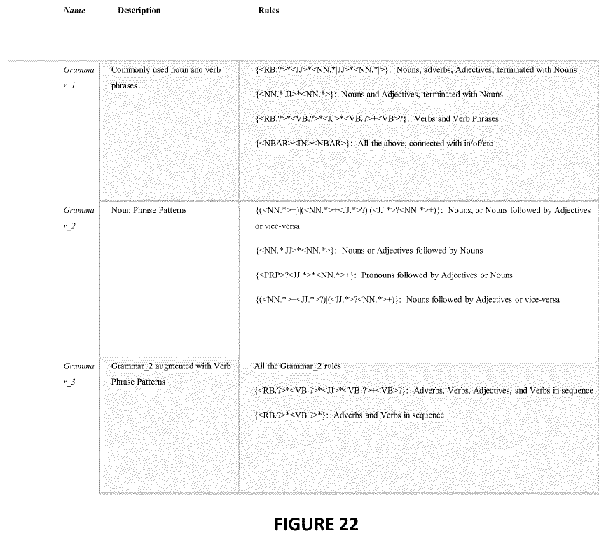

Returning to the overall method of keyword generation in FIG. 10, the candidate extraction (process 53 and component 103) are now described in more detail with reference to FIG. 15. The process in FIG. 15 involves creation of an initial list of all the keywords or phrases that are a part of the document and are ready for analysis and filtering to create the final list of keywords. The data pre-processing steps include: removal of stop words and lower casing. FIG. 15 illustrates how standard natural language toolkit (NLTK) libraries (see www.nltk.org for further details of these known tools) are used to create n-grams from documents. The choice of ‘n’ in the n-gram (151) is based on the analysis of the distribution of length of a keyword for the full corpus to generate an n-gram candidate score (152). Another set of candidate list is generated using Noun and Verb Phrases (NVP) (153) to generate a NVP candidate score (154). Together these are considered as a set of candidate keywords. The NVP rules were curated based on best performing combinations from prior implementation. An example of the NVP rules are set forth in FIG. 22.

As shown in FIG. 15, the NVP candidates 154 and the N-gram candidates may both be fed into a process 155 to reduce redundancies of keywords. In one implementation, the redundancy of the keywords may be reduced using a maximal marginal relevance (MMR) process. The reducing redundancy of the keywords is needed since it is likely that the keyword candidate list has several candidates that are quite like each other. Thus, there is a need to reduce such redundancies and make sure that the candidates are diverse enough, while at the same time they can describe the concept of the document. The MMR method creates diversity in keywords while trading off the redundancies. The mathematical expression implemented in the MMR model is shown in FIG. 16 where N is the number of documents in the domain/corpus, C is the ordered set of candidates generated by the model while S is the re-ordered set generated by the MMR function. For a given document D₁ that has an ordered set of candidates C, similarity is calculated between a target candidate cᵢ and the document and the resultant is multiplied by a redundancy factor (λ). This is the second part of equation i.e., sim2 function. Similarity between the target candidate cᵢ and all other candidates cⱼ for the document is calculated and the maximum similarity value is multiplied by diversity factor (1-X). This is the first part of the equation i.e., sim1 function. The difference between the two is the MMR score. The process 155 is iterated for all cᵢ∈C and in each iteration, the candidate with maximum value is added to the final set S (argmax function). Thus, for a given document, after each iteration, the final set S is appended with one candidate until the original ordered candidate list is re-ordered from C to S.

### Keyword Scoring

Returning to FIG. 10, the keyword scorer component 104 and the keyword scoring candidate keywords process 54 are now described in more detail. The keyword scorer 104 has two major components that is uniquely applied to calculate the score and rank each keyword at the domain level instead of corpus level like is done in typical keyword generating techniques. Firstly, the mathematical formula that determines the term-domain relevance is converted into an unsupervised learning algorithm. Next, the algorithm is applied to both the NVP based candidate list and N-gram candidate list to generate scores using two different strategies. Finally, redundancies in the terms and scores are reduced to create a ranked list of keywords.

The calculation of term-domain relevance is a term-domain score of a candidate term for each domain by penalizing the score if there is presence of the same keyword in the contrasting domain. This is unlike the usual term frequency-inverse document frequency (TF-IDF) score of a term which is a single value across the entire corpus. The equation shown in FIG. 17 may be used to calculate the term-domain score for every candidate term and domain combination resulting in a score for a given term frequency t in the domain d and the contrasting domains G. As can be seen, if the frequency of a given term in the contrasting domain (tfₜ^{(g)}) is zero, term-domain-frequency (term−domain−fₜ^{(d)}) would be the same as the term frequency (tfₜ). If the term appears in multiple contrasting domains in higher frequencies, the denominator increases in geometric proportions reducing the total value of term-domain-frequency. In a way, this feature penalizes the importance of a term for a domain based on its presence in other domains, instead of penalizing it based on the frequency in other documents of the corpus as done in the usual method TF-IDF.

During the keyword scoring, the domain in the equation in FIG. 17 is equivalent to a business category assigned to the document. In the keyword scorer model, the term-domain relevance score is utilized as a basis for extracting keywords in the form of unsupervised method. The term-domain score is applied to the candidate keywords (from NVP, N-gram) to create a comprehensive score for all the candidates. The score is then used to rank and sort the list as per their importance. Since a term score is dependent on the domain in which it was used, same terms may show different scores and ranking if used in different domains.

In one implementation, the keyword scorer uses term-domain-frequency to extract keywords from contents and score them in the context of categories and topics. The keyword scorer may automatically extract top ‘K’ keywords from business relevant contents which may be fed into keyword cluster and ranking process. The model may be a Term-Domain Score architecture that is unsupervised, uses 1 million documents for training and performs the preprocessing described above. The tokenization may be WordPiece and the embeddings may be MiniLM and the model may be classified as statistical learning that uses natural language processing, the source of training data are known OAGKX, SCOPUS data sets and the training infrastructure is a 32 GB CPU. The training data may have a 512K token limit and the model name is a proprietary term-domain-fₜ that performs cosine similarity and the thresholds for the training data may depend on the size of document, but may be a Max of 10 keywords per document.

In a preferred implementation, the data preparation for the training data may be done based on a sample of 100,000 documents are extracted from OAGKX, an open-source corpus of content with labelled keywords. This is done as running 23M data for training requires powerful computational resources. Full 19.5K documents from SCOPUS are used for modelling. Each document includes title, abstract, and golden keywords and titles that are in the range of 3-25 tokens are included and abstracts in the range of 50-400 tokens are included. Articles that have less than 2 and more than 12 keywords are discarded and keyword strings that have more than 20 tokens are also removed. Occurrences of numbers, formulas, punctuations, and special characters are deleted from the text. For the resulting data, full abstract, titles and golden keywords are tokenized, but stemming, Lemma, and Stop word removal are not done at this stage.

### Keyword Dictionary

Returning to FIG. 10, the high value keyword dictionary 105 and the keyword ranker and recommender process 56 are now described in more detail. This is a part of the keyword recommendation module (analysis-recommendation-explanation). A dictionary of high-value keywords is curated by extracting keywords per business category and topic from several real-world source of documents. The sources include SEO keywords that is received from client and partner, and topic and keywords from business relevant content curated from millions of documents per day from business website.

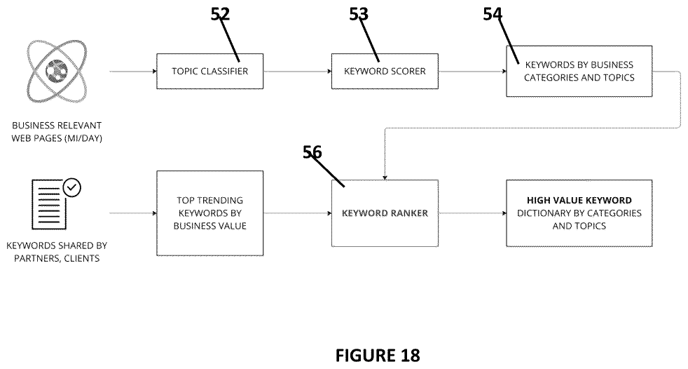

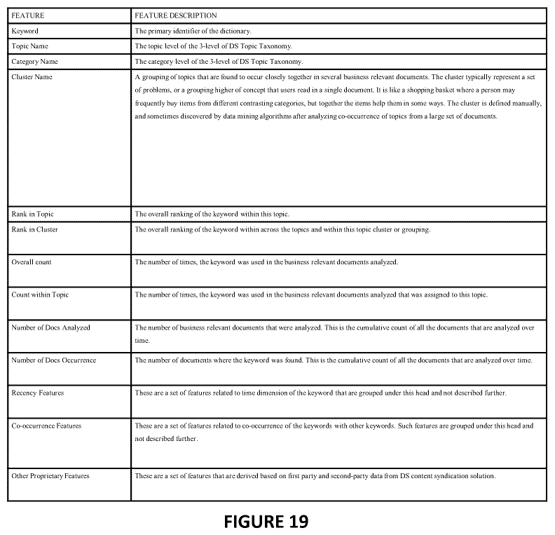

The dictionary is built and maintained by a ‘Keyword Clustering and Ranker’ algorithm shown in FIG. 18. Millions of business relevant contents are analyzed daily (and processed through the already described processes 52-54 to generate keywords) to contribute to the periodic maintenance of the dictionary. The keyword ranker process 56 discovers the most important associations of keywords and topics and maintains the list of top K keywords per topic. The relationship between keywords and topics is found to be many-to-many. The importance of keywords is determined by collating multiple features in real-time. Some examples of the features are shown in a chart in FIG. 19 wherein the chart is not an exhaustive list.

Returning to FIG. 18, the detailed process for curating the high value keywords is described in more detail. Most of the components that contribute to the overall process comes from the ‘keyword scorer’ model described previously. The execution of the scorer model over a period on millions of business relevant documents generates the features that determine the value of a keyword within the proprietary topic taxonomy. Additionally, data curated from clients, partners, and second parties contribute to the clustering and ranking in form of inherent business value of the keywords. The dictionary is described in the previous section, and the process of curating the features of the dictionary forms the part of keyword clustering and ranker algorithm. The ranker algorithm then finally generates associations and ranks and updates the high-value keyword dictionary that can be used by the recommendation module or any other use case.

### Keyword Cluster and Ranking

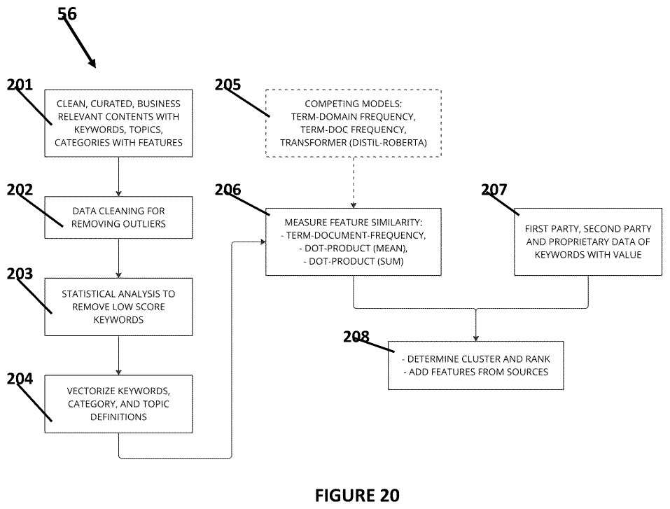

FIG. 20 describes the process to cluster and rank keywords 56 and curate the high-value keyword dictionary 105. The process starts with creating (201) a corpus of clean, business relevant contents that have keywords, business categories and topics associated with the corpus. Several features shown in the dictionary are determined at this stage and is carried over to the end of the process. Using the clean corpus of documents, the dataset is cleansed (202) further to remove outliers in a known manner by (a) removing duplicates or near-duplicate contents, (b) using open-source document vector analysis library like CleanLab to remove out-of-distribution (OOD) documents, and (c) filtering down contents based on the size of the document. The keywords and category, topic associations thus obtained are further filtered (203) to remove low score terms by applying a statistical threshold over the keyword score from the previously described scorer model and the number of keywords per document is capped based on the size of the document.

Next, the keywords, topic definitions, and category definitions are vectorized (204) using an known open-source embedding library. In this method, three competing models are built (process 205 shown in FIG. 20 as dotted box). The first model is based on the known term-domain-frequency technique, the second model uses a transformer architecture, and the third one uses a modified TF-IDF algorithm. The first method was described in detail above for the scorer model. The second model that uses a transformer architecture that was fine-tuned using Distil-RoBERTa base transformer. Both these methods are evaluated and discarded due to sub-optimal performance.

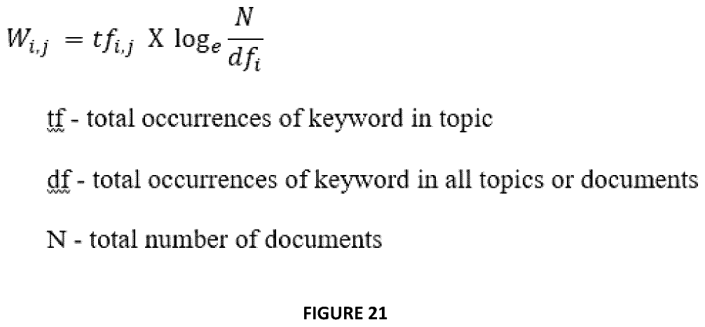

The third method uses a “modified TF-IDF algorithm” which refers only to the predicted keywords and not the occurrence of keywords within the document. The mathematical expression that is implemented as an algorithm for the clustering and ranking is shown in FIG. 21. Two more similarity calculations may be performed on the results using mean and sum of dot-products (206) that is in addition to the modified TF-IDF. The probabilities are processed using two different strategies to calculate the high affinities between keywords and topics. The strategies are: (i) mean of the dot-product of the probabilities of keywords and topics, and (iii) sum of dot-product of the probabilities of keywords and topics. For example, if there are 2 topics and 2 keywords in document 1 which are:
{topic a: topic_probability a, topic b: topic_probablity b}
{keyword1: keyword_probability1, keyword2: keyword_probability2}

The weights for the keywords would be:
keyword1 weight for topic A=topic_probability_a*keyword_probability1
keyword2 weight for topic A=topic_probability_a*keyword_probability2
keyword1 weight for topic B=topic_probability_b*keyword_probability1
keyword2 weight for topic B=topic_probability_b*keyword_probability2

Thus, the weights for the 2 keywords are different for the 2 topics. Furthermore, keyword1 under the same topic A will have a different weight based on the probabilities of the 2 entities. To extract the final weights of the keywords per topic, the sum and mean are extracted. In another component of the solution, proprietary data from internal database and partners (207) that have well-defined business value in form of scores and numbers are included. Then, the TF-IDF score, mean of dot-product, sum of dot-product, and the business value score are all combined to determine the rank of keywords within each topic, the topical scores are aggregated at the cluster level and all the features from different sources are all combined (208) to update the high-value keyword dictionary.

In a preferred implementation, the keyword ranking model ranks top 1000 keywords for each topics and cluster level using real-world data and builds the high value keyword dictionary as described above using a modified term-document rank statistical learning algorithm that is unsupervised and is trained on 3 million documents. The tokenization may be done by commercially available WordPiece and the embeddings may be done by commercially available MiniLM. The keyword ranker may be trained using a 32 GB CPU.

### Other Use Cases

The keyword solution described above can be applied to other use cases. The below use cases complement the content syndication and helps expand the utility of the solution in different context. In a first alternative use case, the keyword system discussed above may be used for the analysis of audio content. In its most basic form, any audio files can be processed using a voice-to-text module and the resultant text can be processed through this system. In this use case, the system and method would improve the capabilities of the system to process text originating from an audio file. This can be expanded further by identifying those words in the voice module that had more emphasis in the form of tone and sentiment of the speech.

A second alternative user case may be keywords by persona in which, instead of extracting keywords in the context of a business category and topic, the system and method may be modified to understand the persona of the user and suggest different keywords accordingly. For example, a text may have several parts that are of interest for different persona like legal, information technology, product, marketing, human resources etc. With a simple modification of mapping personas to business categories and topics, the system can be used to extract relevant keywords depending on the occupation, skill, and job function of the end user.

A Persona in the context of a B2B document may be represented by several job attributes of the person (industry association, job function, job area and occupations). A document that is of business relevance may be processed through several models listed below to collate the specific persona attribution (further details of these models are described in U.S. patent application Ser. No. ______ filed on the same day that is incorporated herein by reference). The process to generate the keywords by persona may include an industry association process in which content may be analyzed and assigned to specific industry or industries based on a machine learning model. The process to generate the keywords by persona may also include a job function process wherein job functions are like departments within an organization. Professionals working in a department may be assigned a job function that has clearly defined roles and responsibilities. Using a machine learning model or a simpler semantic similarity engine, a text may be mapped to one or more job function descriptions.

The process to generate the keywords by persona may include a job areas process wherein job areas are granular classification of job functions and the solution to map a text to an area of expertise of the person may be similar to job function. The process to generate the keywords by persona may include an occupations process wherein occupations are well-defined industry standardization for professionals. It is a form of aggregation of typical roles and responsibilities of the person irrespective of the industry or the company to which the person belongs. Business contents can be mapped to occupation code using machine learning techniques. The relevance of a given document to an industry, job function, area, and occupation is determined using the above approach. These four attributes also broadly define a persona that is interested to read the content, and hence are a set of features for training keyword association models which would function like the topic-keyword association processes 52 and 102 in FIG. 10.

The foregoing description, for purpose of explanation, has been with reference to specific embodiments. However, the illustrative discussions above are not intended to be exhaustive or to limit the disclosure to the precise forms disclosed. Many modifications and variations are possible in view of the above teachings. The embodiments were chosen and described in order to best explain the principles of the disclosure and its practical applications, to thereby enable others skilled in the art to best utilize the disclosure and various embodiments with various modifications as are suited to the particular use contemplated.

The system and method disclosed herein may be implemented via one or more components, systems, servers, appliances, other subcomponents, or distributed between such elements. When implemented as a system, such systems may include and/or involve, inter alia, components such as software modules, general-purpose CPU, RAM, etc. found in general-purpose computers. In implementations where the innovations reside on a server, such a server may include or involve components such as CPU, GPU, TPU, RAM, etc., such as those found in general-purpose computers.

Additionally, the system and method herein may be achieved via implementations with disparate or entirely different software, hardware and/or firmware components, beyond that set forth above. With regard to such other components (e.g., software, processing components, etc.) and/or computer-readable media associated with or embodying the present inventions, for example, aspects of the innovations herein may be implemented consistent with numerous general purpose or special purpose computing systems or configurations. Various exemplary computing systems, environments, and/or configurations that may be suitable for use with the innovations herein may include, but are not limited to: software or other components within or embodied on personal computers, servers or server computing devices such as routing/connectivity components, hand-held or laptop devices, multiprocessor systems, microprocessor-based systems, set top boxes, consumer electronic devices, network PCs, other existing computer platforms, distributed computing environments that include one or more of the above systems or devices, etc.

In some instances, aspects of the system and method may be achieved via or performed by logic and/or logic instructions including program modules, executed in association with such components or circuitry, for example. In general, program modules may include routines, programs, objects, components, data structures, etc. that perform particular tasks or implement particular instructions herein. The inventions may also be practiced in the context of distributed software, computer, or circuit settings where circuitry is connected via communication buses, circuitry or links. In distributed settings, control/instructions may occur from both local and remote computer storage media including memory storage devices.

The software, circuitry and components herein may also include and/or utilize one or more type of computer readable media. Computer readable media can be any available media that is resident on, associable with, or can be accessed by such circuits and/or computing components. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and can accessed by computing component. Communication media may comprise computer readable instructions, data structures, program modules and/or other components. Further, communication media may include wired media such as a wired network or direct-wired connection, however no media of any such type herein includes transitory media. Combinations of the any of the above are also included within the scope of computer readable media.

In the present description, the terms component, module, device, etc. may refer to any type of logical or functional software elements, circuits, blocks and/or processes that may be implemented in a variety of ways. For example, the functions of various circuits and/or blocks can be combined with one another into any other number of modules. Each module may even be implemented as a software program stored on a tangible memory (e.g., random access memory, read only memory, CD-ROM memory, hard disk drive, etc.) to be read by a central processing unit to implement the functions of the innovations herein. Or, the modules can comprise programming instructions transmitted to a general-purpose computer or to processing/graphics hardware via a transmission carrier wave. Also, the modules can be implemented as hardware logic circuitry implementing the functions encompassed by the innovations herein. Finally, the modules can be implemented using special purpose instructions (SIMD instructions), field programmable logic arrays or any mix thereof which provides the desired level performance and cost.

As disclosed herein, features consistent with the disclosure may be implemented via computer-hardware, software, and/or firmware. For example, the systems and methods disclosed herein may be embodied in various forms including, for example, a data processor, such as a computer that also includes a database, digital electronic circuitry, firmware, software, or in combinations of them. Further, while some of the disclosed implementations describe specific hardware components, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various routines, processes and/or operations according to the invention or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the invention, or it may be more convenient to construct a specialized apparatus or system to perform the required methods and techniques.

Aspects of the method and system described herein, such as the logic, may also be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: memory devices, microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various logic and/or functions disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) though again does not include transitory media. Unless the context clearly requires otherwise, throughout the description, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

Although certain presently preferred implementations of the invention have been specifically described herein, it will be apparent to those skilled in the art to which the invention pertains that variations and modifications of the various implementations shown and described herein may be made without departing from the spirit and scope of the invention. Accordingly, it is intended that the invention be limited only to the extent required by the applicable rules of law.

While the foregoing has been with reference to a particular embodiment of the disclosure, it will be appreciated by those skilled in the art that changes in this embodiment may be made without departing from the principles and spirit of the disclosure, the scope of which is defined by the appended claims.

What is claimed is:

1. A computer implemented method, comprising:
receiving, at a computer system, a plurality of pieces of content;
assigning, by a topic classifier machine learning model executed by the computer system, a business category and topic to each piece of content wherein each piece of content has an assigned topic;
extracting, by a candidate term extractor executed by the computer system, a set of candidate keyword terms from each piece of content having the assigned topic;
scoring, by a keyword scorer machine learning model executed by the computer system, each of the set of candidate keyword terms to generate a set of scored keywords;
ranking, by a keyword ranking machine learning model executed by the computer system, each of the set of scored keywords based on the score assigned to each keyword; and
outputting, by the computer system, one or more scored, ranked keywords.

2. The method of claim 1 further comprising training each machine learning model.

3. The method of claim 2, wherein assigning the business category and topic to each piece of content further comprises using a trained multi-label multiclass topic classifier machine learning model.

4. The method of claim 3, wherein assigning the business category and topic to each piece of content further comprises using a trained BERT language large transformer.

5. The method of claim 2, wherein scoring each of the set of candidate keyword terms further comprises scoring each of the set of candidate keyword terms using cosine similarity.

6. The method of claim 5, wherein scoring each of the set of candidate keyword terms further comprises scoring each of the set of candidate keyword terms using a term-domain-ft model.

7. The method of claim 1, wherein extracting the set of candidate keyword terms further comprises using syntactical rules to generate a first set of candidate keyword terms and using statistical rules to generate a second set of candidate keyword terms and generating a final set of candidate keyword terms by reducing redundancies in the first and second set of candidate keyword terms.

8. The method of claim 7, wherein the first set of candidate keyword terms are noun-verb phrase candidates, the second set of candidate keyword terms are N-gram candidates and wherein generating the final set of candidate keyword terms further comprises performing a maximal marginal relevance analysis to reduce the redundancies.

9. The method of claim 1, wherein ranking each of the set of scored keywords further comprises using a modified term frequency-inverse document frequency (TF-IDF) process to rank the set of scored keywords.

10. The method of claim 1 further comprising syndicating content using the one or more scored, ranked keywords.

11. The method of claim 11, wherein each of the plurality of piece of content is one of a document, a text conversion of a piece of audio content and a persona.

12. The method of claim 1, wherein outputting the one or more scored, ranked keywords further comprises outputting, through an application programming interface of the computer system to a third party, the one or more scored, ranked keywords.

13. A system, comprising:
a computer system having a processor and a memory and a plurality of lines of instructions executed by the processor that configures the computer system to:
receive a plurality of pieces of content;
assign, by a topic classifier machine learning model, a business category and topic to each piece of content wherein each piece of content has an assigned topic;
extract, by a candidate term extractor, a set of candidate keyword terms from each piece of content having the assigned topic;
score, by a keyword scorer machine learning model, each of the set of candidate keyword terms to generate a set of scored keywords;
rank, by a keyword ranking machine learning model, each of the set of scored keywords based on the score assigned to each keyword; and
output one or more scored, ranked keywords.

14. The system of claim 13, wherein the computer system is further configured to train each machine learning model.

15. The system of claim 14, wherein the computer system is further configured to use a trained multi-label multiclass topic classifier machine learning model to assign the business category and topic to each piece of content.

16. The system of claim 15, wherein the computer system is further configured to use a trained BERT language large transformer to assign the business category and topic to each piece of content.

17. The system of claim 14, wherein the computer system is further configured to score each of the set of candidate keyword terms using cosine similarity.

18. The system of claim 17, wherein the computer system is further configured to use a term-domain-ft model to score each of the set of candidate keyword terms using cosine similarity.

19. The system of claim 13, wherein the computer system is further configured to use syntactical rules to generate a first set of candidate keyword terms, use statistical rules to generate a second set of candidate keyword terms and generate a final set of candidate keyword terms by reducing redundancies in the first and second set of candidate keyword terms.

20. The system of claim 19, wherein the first set of candidate keyword terms are noun-verb phrase candidates, the second set of candidate keyword terms are N-gram candidates and wherein the computer system is further configured to perform a maximal marginal relevance analysis to reduce the redundancies in the first and second set of candidate keyword terms.

21. The system of claim 13, wherein the computer system is further configured to use a modified term frequency-inverse document frequency (TF-IDF) process to rank the set of scored keywords.

22. The system of claim 13, wherein the computer system is further configured to syndicate content using the one or more scored, ranked keywords.

23. The system of claim 13, wherein each of the plurality of piece of content is one of a document, a text conversion of a piece of audio content and a persona.

24. The system of claim 13, wherein the computer system further comprises an application programming interface and wherein the computer system is further configured to output, using the application programming interface the one or more scored, ranked keywords to a third party.
